(19) United States
(12) Patent Application Publication
(10) Pub. No.: US 2020/0093318 A1
(43) Pub. Date: Mar. 26, 2020

(54) Beverage Supply Device

(71) Applicant: SANDEN RETAIL SYSTEMS CORPORATION, Isesaki-shi (JP)

(72) Inventor: Shinya ARAI, Isesaki-shi (JP)

(21) Appl. No.: 16/612,678

(22) PCT Filed: Apr. 23, 2018
(86) PCT No.: PCT/JP2018/017356

§ 371 Date: Nov. 11, 2019

(30) Foreign Application Priority Data
May 19, 2017 (JP) 2017-100330

(51) Int. Cl. A47J 31/46; A47J 31/10; B67D 1/12

(52) U.S. Cl. CPC A47J 31/46; B67D 1/1256; A47J 31/10

(57) ABSTRACT

It is an object of the present invention to prevent post-drip from a nozzle by means of a simple structure. A coffee machine 1 that supplies coffee into a cup placed at a cup station from a coffee nozzle 23, a distal end of which is disposed above the cup, is provided with a buffer nozzle 61 above the coffee nozzle 23, in which a beverage is supplied to the cup vertically below from the buffer nozzle 61 via the coffee nozzle 23 and a lateral discharge part 82 that discharges coffee post-drip dripping from the buffer nozzle 61 to the side of the coffee nozzle 23 is provided on the side surface of the coffee nozzle 23.

### TECHNICAL FIELD

The present invention relates to a beverage supply apparatus that supplies and provides a beverage into a cup.

### BACKGROUND ART

Beverage supply apparatuses which are installed in a shop or the like to automatically pour and provide a beverage such as coffee into cups are developed.

For example, a beverage supply apparatus described in Patent Document 1 has a structure of pouring and supplying a beverage such as coffee from a nozzle into a cup placed below the nozzle. Furthermore, the beverage supply apparatus according to Patent Document 1 is provided with an actuator such as an electric motor at a bracket that supports the nozzle. The apparatus is configured such that the nozzle can be moved by the actuator and when the supply of the beverage into the cup is completed, the nozzle is moved to a standby position retracted from above the cup. After the supply of the beverage into the cup is completed, it is thereby possible to prevent the beverage remaining in the nozzle from dripping from the nozzle distal end and being stuck around the cup, so-called post-drip.

### PRIOR ART DOCUMENT

### Patent Document

Patent Document 1: Japanese Utility Model Laid-Open No. S62-71787

### SUMMARY OF THE INVENTION

### Problems to be Solved by the Invention

However, the beverage supply apparatus, the nozzle of which is made movable described in Patent Document 1 needs to be configured such that the nozzle is made to be movable and an actuator for moving the nozzle needs to be provided, which will make the configuration in the vicinity of the nozzle complicated.

The present invention has been devised to solve such a problem and it is an object of the present invention to provide a beverage supply apparatus in a simple configuration, capable of preventing post-drip from the nozzle.

### Means for Solving the Problems

In order to achieve the above object, an aspect of a beverage supply apparatus of the present invention is directed to a beverage supply apparatus that supplies a beverage into a cup placed at a cup station from a nozzle, a distal end of which is disposed above the cup, in which the nozzle pours the beverage vertically downward and a lateral discharge part that discharges the beverage passing through the nozzle at a flow rate equal to or less than a predetermined value to a side of the nozzle is provided.

The nozzle is preferably constructed of a first nozzle and a second nozzle disposed above the first nozzle.

Alternatively, the beverage supply apparatus of the present invention is a beverage supply apparatus that supplies a beverage into a cup placed at a cup station from a first nozzle, a distal end of which is disposed above the cup, in which a second nozzle is provided above the first nozzle, the first nozzle pours the beverage vertically downward, and a lateral discharge part that discharges the beverage passing through the first nozzle at a flow rate equal to or less than a predetermined value to a side of the nozzle is provided.

The lateral discharge part preferably discharges post-drip after pouring the beverage from the second nozzle to a side of the first nozzle.

The second nozzle preferably pours the beverage vertically downward.

The first nozzle and the second nozzle are preferably disposed coaxially on a vertical line.

A guide for guiding post-drip of the beverage from a pour spout of the second nozzle to the lateral discharge part may be preferably provided.

An end part of the guide preferably protrudes toward the pour spout of the second nozzle.

An undersurface of the guide is preferably treated to produce a capillary phenomenon.

The treatment to produce a capillary phenomenon is preferably a groove provided in the undersurface of the guide.

A bottom end part of the guide is preferably inclined diagonally downward from the pour spout of the second nozzle toward the outside.

The bottom end part of the guide is preferably inclined at two stages such that a region outside the region on the pour spout side of the second nozzle is more steeply inclined.

The lateral discharge part may be preferably provided with discharge restricting means for damming up beverage discharge at a flow rate equal to or above a predetermined value to a side of the first nozzle.

### Advantageous Effects of the Invention

According to the beverage supply apparatus of the present invention, the lateral discharge part is provided on the side face of the nozzle (or the first nozzle) that pours a beverage vertically downward, the beverage passing through the nozzle at a flow rate equal to or less than a predetermined value is discharged by the lateral discharge part to the side of the nozzle, and so after the beverage is poured vertically downward from the nozzle, post-drip of the beverage from the nozzle is discharged by the lateral discharge part to the side of the nozzle.

Therefore, it is possible to restrain, with a simple configuration, post-drip after beverage discharge from being discharged below the nozzle and prevent mixture into the cup placed below the nozzle.

### BRIEF DESCRIPTION OF THE DRAWINGS

FIG. 1 is a front outline view of a coffee machine according to an embodiment of the present invention;

FIG. 2 is a front view of the coffee machine when a door is opened;

FIG. 3 is a front view illustrating an overall structure of a nozzle unit and a nozzle lower tray;

FIG. 4 is a top view illustrating states of a nozzle support unit and the nozzle lower tray when milk is not supplied;

FIG. 5 is a top view illustrating states of the nozzle support unit and the nozzle lower tray when milk is supplied;

FIG. 6 is a top view of the nozzle lower tray;

FIG. 7 is a perspective view of the nozzle lower tray;

FIG. 8 is a traverse cross-sectional view illustrating states of the nozzle unit and a nozzle moving unit when milk is supplied;

FIG. 9 is a traverse cross-sectional view illustrating states of the nozzle unit and the nozzle moving unit while the door is being opened;

FIG. 10 is a side view illustrating a configuration of a buffer and a coffee nozzle;

FIG. 11 is a longitudinal cross-sectional view of the buffer and the coffee nozzle;

FIG. 12 is a side view of the buffer in the vicinity of the buffer nozzle;

FIG. 13 is a bottom view of the buffer illustrating a shape of the vicinity of the buffer nozzle;

FIG. 14 is a side view illustrating a shape of the coffee nozzle;

FIG. 15 is a top view illustrating the shape of the coffee nozzle; and

FIG. 16 is a rear view illustrating the shape of the coffee nozzle.

### MODE FOR CARRYING OUT THE INVENTION

Hereinafter, an embodiment of the present invention will be described with reference to the accompanying drawings.

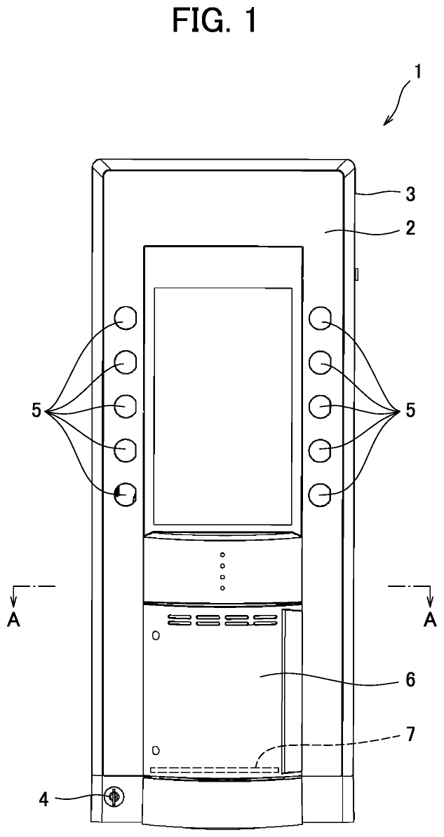

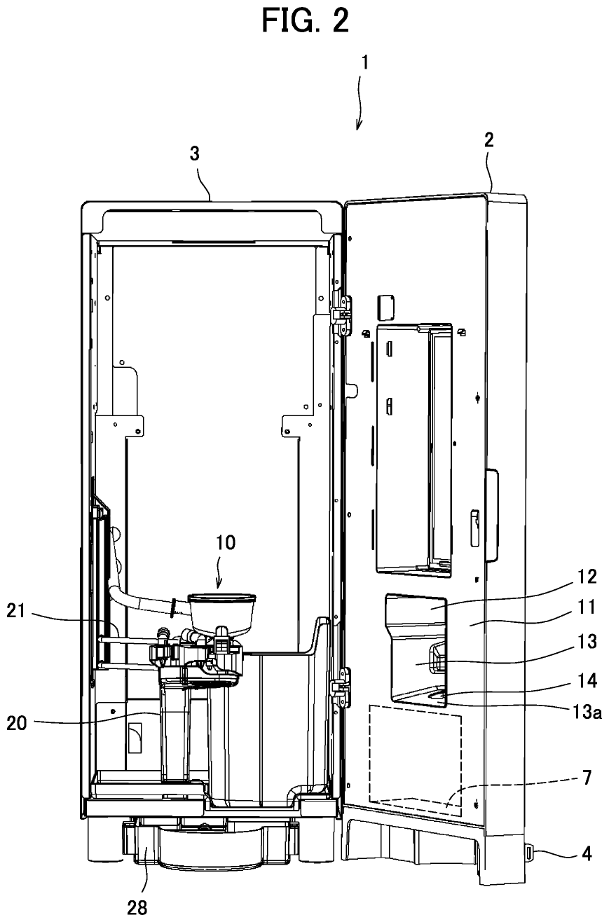

FIG. 1 is an outline view of a coffee machine 1 according to an embodiment of the present invention. FIG. 2 is a front view of the coffee machine 1 when a door 2 is opened.

The coffee machine 1, which is a beverage supply apparatus according to an embodiment of the present invention is an apparatus placed at a store such as a convenience store to provide a beverage such as coffee only or a mixture of coffee and milk such as cafe latte or cappuccino.

As shown in, FIGS. 1 and 2, the coffee machine 1 of the present embodiment is provided with a substantially rectangular box-shaped body part 3 and a rectangular box-shaped door 2 that covers the front surface of the body part 3.

Inside the body part 3, there are a canister for storing coffee beans, a hot water tank, a raw milk tank for storing raw milk, a whipping unit for whipping the raw milk, a coffee mill for milling the coffee beans and an extraction unit for extracting coffee, or the like, which are not shown.

The door 2 is formed into a box shape including a space therein and is supported by the body part 3 so as to be opened or closed in a left-right direction swinging with the end part on the right side as a fulcrum. The door 2 can be locked in a closed state by a removable key 4 and is opened when a raw material such as coffee beans is supplied or at the time of maintenance such as cleaning.

Selection switches 5 for selecting a beverage such as coffee, cafe latte are provided on the front of the door 2. A slide door 6 is provided at the front bottom of the door 2 and a cup station 7 at which a cup is placed is provided in the slide door 6. The cup station 7 is provided in the door 2.

The body part 3 is provided with a nozzle unit 10 that supplies a beverage into a cup from the extraction unit, the raw milk tank or the like. The nozzle unit 10 is disposed so that it is positioned above the cup station 7 when the door 2 is closed.

A space 12 for housing the nozzle unit 10 in the door 2 is formed in a rear surface panel 11 positioned on the body part side of the door 2 while the door 2 is closed. The space 12 is positioned above the cup station 7, covered with a partition wall 13 on the top, bottom, left and right, and is partitioned from other spaces in the door 2. Note that a hole 14 for allowing a beverage to pass from the nozzle unit 10 to the cup station 7 side is opened in the partition wall 13a below.

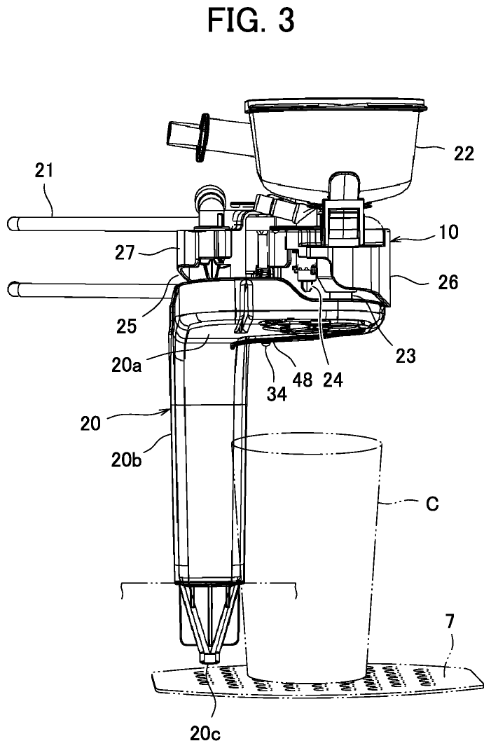

FIG. 3 is a front view illustrating a configuration of the nozzle unit 10 and a nozzle lower tray 20.

As shown in FIG. 3, the nozzle unit 10 is supported by the body part 3 detachably therefrom via a support member 21 formed by bending a round bar into a substantially U shape.

The nozzle unit 10 is provided with a buffer 22 that temporarily stores coffee extracted by the extraction unit, a coffee nozzle 23 (first nozzle, nozzle) fixed below the buffer 22 to supply coffee from a pour spout below the buffer 22, a hot water/water nozzle 24 that supplies other beverages such as hot water/water, a milk nozzle 25 that supplies raw milk supplied from the raw milk tank or milk obtained by whipping the raw milk, a fixed nozzle support unit 26 that supports the buffer 22, the coffee nozzle 23 and the hot water/water nozzle 24, and a movable nozzle support unit 27 that supports the milk nozzle 25.

The nozzle lower tray 20 is provided below the nozzle unit 10. The nozzle lower tray 20 includes a tray 20a that receives post-drip from the milk nozzle 25. The tray 20a is placed at a position in the vertical direction between each nozzle 23, 24 or 25 and the cup C disposed at the cup station 7. A cylinder part 20b extending in the vertical direction integrally molded with the tray 20a is provided at a rear end part of the nozzle lower tray 20. The cylinder part 20b is provided with a discharge port 20c at its bottom end part and detachably fixed at a lower part of the body part 3. The top surface of the tray 20a is inclined downward toward the cylinder part 20b, a liquid dropping on the top surface of the tray 20a is directed to the cylinder part 20b, and is configured to flow downward through the cylinder part 20b and be discharged into a drainage tray 28 placed below the body part 3.

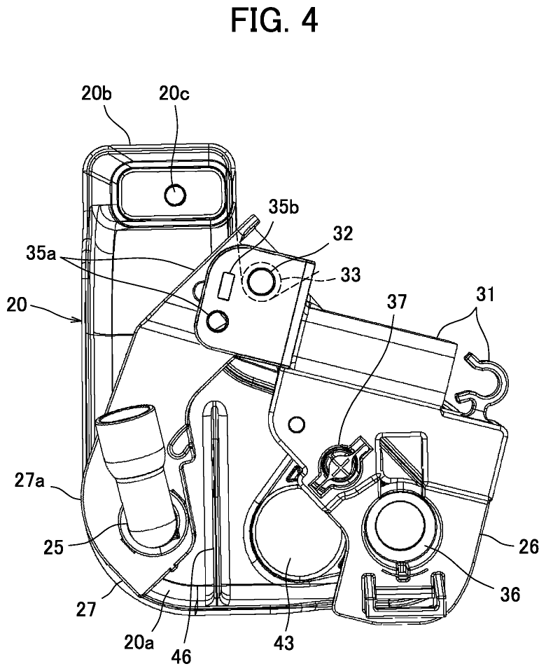

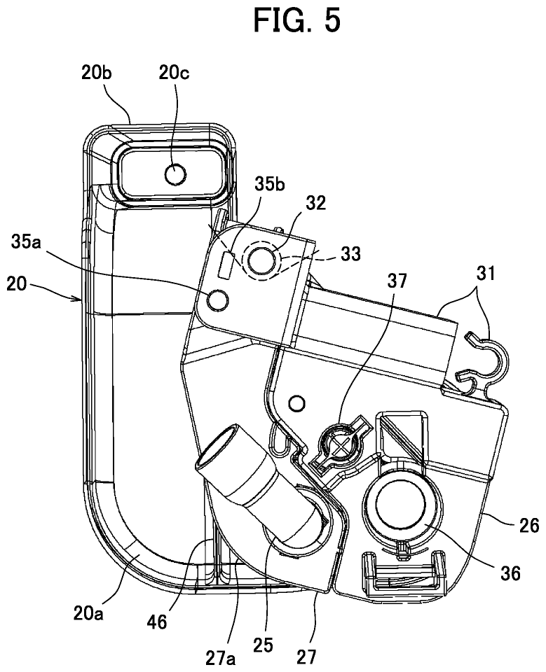

FIGS. 4 and 5 are top views illustrating configurations of the nozzle support units 26 and 27, and the nozzle lower tray 20. FIG. 4 illustrates a state when milk is not supplied and FIG. 5 illustrates a state when milk is supplied.

As shown in FIGS. 4 and 5, the fixed nozzle support unit 26 is provided with a support member fixing part 31 detachably fixed to a bent part of the support member 21.

The movable nozzle support unit 27 is horizontally swingably supported with respect to the fixed nozzle support unit 26 via a pin 32 extending in the vertical direction.

A torsion spring 33 biasing the movable nozzle support unit 27 toward a direction away from the fixed nozzle support unit 26 is provided around the circumference of the pin 32. The fixed nozzle support unit 26 or the movable nozzle support unit 27 is provided with a stopper (not shown) for restricting the movable nozzle support unit 27, when it moves in a direction away from the fixed nozzle support unit 26 up to a predetermined position (standby position), from further moving in the separating direction.

Thus, the movable nozzle support unit 27 is configured to be swingable between the standby position away from the fixed nozzle support unit 26 shown in FIG. 4 and a position in contact with the fixed nozzle support unit 26 (supply position) shown in FIG. 5. With a bias by the torsion spring 33, the movable nozzle support unit 27 is normally located at the standby position shown in FIG. 4.

Furthermore, the fixed nozzle support unit 26 is provided with a protruding part 34 that protrudes downward in such a way that its distal end is tapered in a downward direction at a lower position coaxial with the pin 32.

The fixed nozzle support unit 26 and the movable nozzle support unit 27 are provided with through holes vertically penetrating regions overlapping in the vertical direction when the movable nozzle support unit 27 is positioned at a supply position. There are two such through holes: a circular through hole 35a and a rectangular through hole 35b into which the distal end part of the key 4 for locking the door 2 can be inserted, which are provided for the fixed nozzle support unit 26 and the movable nozzle support unit 27 respectively. As shown in FIG. 5, with the movable nozzle support unit 27 positioned at the supply position, an insertable pin or the distal end part of the key 4 is inserted into at least one of the two through holes 35a and 35b, and it is thereby possible to hold the movable nozzle support unit 27 positioned at the supply position.

The fixed nozzle support unit 26 is provided with a coffee nozzle support hole 36 perforated in the vertical direction to support the coffee nozzle 23 inserted from above and a hot water/water nozzle support hole 37 perforated in the vertical direction to support the hot water/water nozzle 24 inserted from above.

The movable nozzle support unit 27 is provided with a milk nozzle support hole perforated in the vertical direction to support the milk nozzle 25 inserted from above. Note that FIGS. 4 and 5 illustrate a state in which the milk nozzle 25 is inserted into the milk nozzle support hole of the movable nozzle support unit 27 and supported.

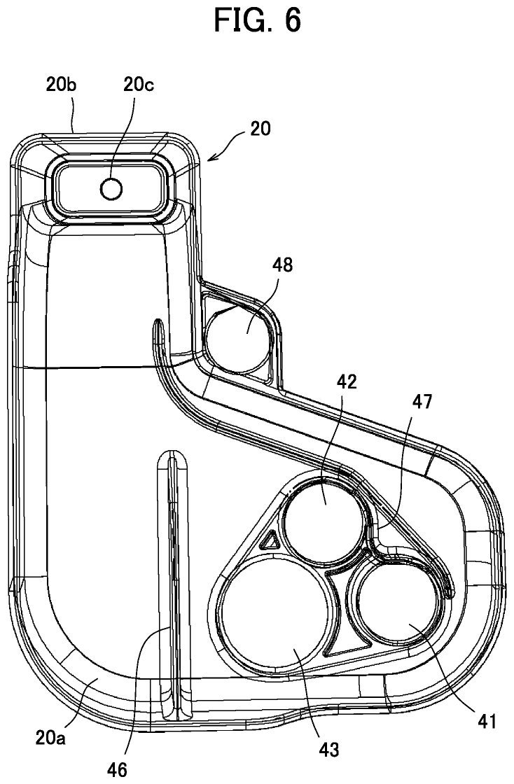

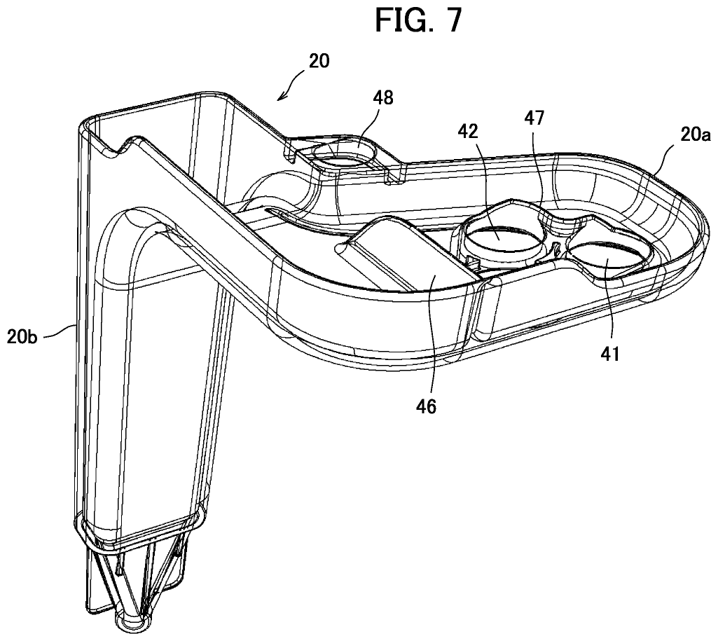

FIG. 6 is a top view of a nozzle lower tray 20. FIG. 7 is a perspective view of the nozzle lower tray 20.

As shown in FIGS. 6 and 7, the tray 20a of the nozzle lower tray 20 is provided with holes 41 and 42 which are slightly larger than the holes of the nozzles 23 and 24 in the regions positioned below the coffee nozzle 23 and the hot water/water nozzle 24 respectively. As described above, although the tray 20a of the nozzle lower tray 20 is placed below the nozzle unit 10, a beverage such as coffee poured vertically downward from the coffee nozzle 23 or the hot water/water nozzle 24 passes through the hole 41 or 42 of the nozzle lower tray 20 and is supplied into the cup C placed at the cup station 7.

The tray 20a of the nozzle lower tray 20 is also provided with a hole 43 in the region positioned below the milk nozzle 25 when the movable nozzle support unit 27 is positioned at the supply position. Milk poured vertically downward from the milk nozzle 25 passes through the hole 43 of the nozzle lower tray 20 and is supplied into the cup C placed at the cup station 7. Sizes and positions of the holes 41, 42 and 43 provided in the tray 20a of the nozzle lower tray 20 are set in such a way that beverages poured from the respective nozzles 23, 24 and 25 do not scatter from the edge of the cup C placed at a predetermined position of the cup station 7 or to the outside of the cup C.

The tray 20a of the nozzle lower tray 20 is provided so as to include the position below the milk nozzle 25 when the movable nozzle support unit 27 is positioned at a standby position and placed so as to surely receive milk dropping from the milk nozzle 25 at the standby position.

The tray 20a of the nozzle lower tray 20 is provided both around the holes 41, 42 and 43 provided below the milk nozzle 25, the coffee nozzle 23 and the hot water/water nozzle 24 when the movable nozzle support unit 27 is positioned at the supply position and at the position below the milk nozzle 25 when the movable nozzle support unit 27 is positioned at the standby position, and these regions are integrally formed, and so it is possible to share the cylinder part 20b that discharges the liquid received at the tray 20a and miniaturize the nozzle lower tray 20.

Furthermore, on the top surface of the tray 20a of the nozzle lower tray 20, there is a first partition part 46 that protrudes upward between the region below the milk nozzle 25 when the movable nozzle support unit 27 is positioned at the standby position and the regions where the holes 41, 42 and 43 are provided so as to partition these regions.

This first partition part 46 allows the milk that has dropped from the milk nozzle 25 when the movable nozzle support unit 27 is positioned at the standby position to be discharged into the cylinder part 20b without flowing into the holes 41, 42 and 43.

On the top surface of the tray 20a, there is also a second partition part 47 that protrudes upward at edges of the hole 41 below the coffee nozzle 23 and the hole 42 below the hot water/water nozzle 24. This is attributable to a structure in which the coffee nozzle 23 is provided with a discharge hole for discharging post-drip of coffee poured from the buffer 22 to a side on the rear side and post-drip of coffee dripping from the discharge hole drops to a region behind the hole 41 and the hole 42 in the tray 20a. This second partition part 47 is configured to cause a liquid such as coffee dropping behind the hole 41 below the coffee nozzle 23 and the hole 42 below the hot water/water nozzle 24 to be discharged into the cylinder part 20b without flowing into the holes 41 and 42.

The nozzle lower tray 20 is provided with a support hole 48 into which a distal end of the protruding part 34 provided below the pin 32 of the fixed nozzle support unit 26 is inserted. The fixed nozzle support unit 26 and the nozzle lower tray 20 are connected by inserting the protruding part 34 of the fixed nozzle support unit 26 into this support hole 48. Therefore, the fixed nozzle support unit 26 is not only supported by the body part 3 via the support member 21 but also supported by the body part 3 via the nozzle lower tray 20. Even if an operator mistakenly contacts and pushes the nozzle lower tray 20 or the nozzle unit 10, for example, during maintenance, it is possible to prevent fall of the nozzle lower tray 20, dropout of the nozzle unit 10, or the like.

When the protruding part 34 of the fixed nozzle support unit 26 is inserted into the support hole 48 of the nozzle lower tray 20, positioning in the horizontal direction of the nozzle lower tray 20 and the fixed nozzle support unit 26 is done. Positionings in the horizontal direction of the respective nozzles 23, 24 and 25, and the nozzle lower tray 20 are precisely done, making it possible to accurately supply a beverage such as milk from the respective nozzles 23, 24 and 25 to the cup C, accurately receive post-drip or scattering of the beverage from the respective nozzles 23, 24 and 25 by the tray 20a of the nozzle lower tray 20 and discharge the beverage into the drainage tray 28.

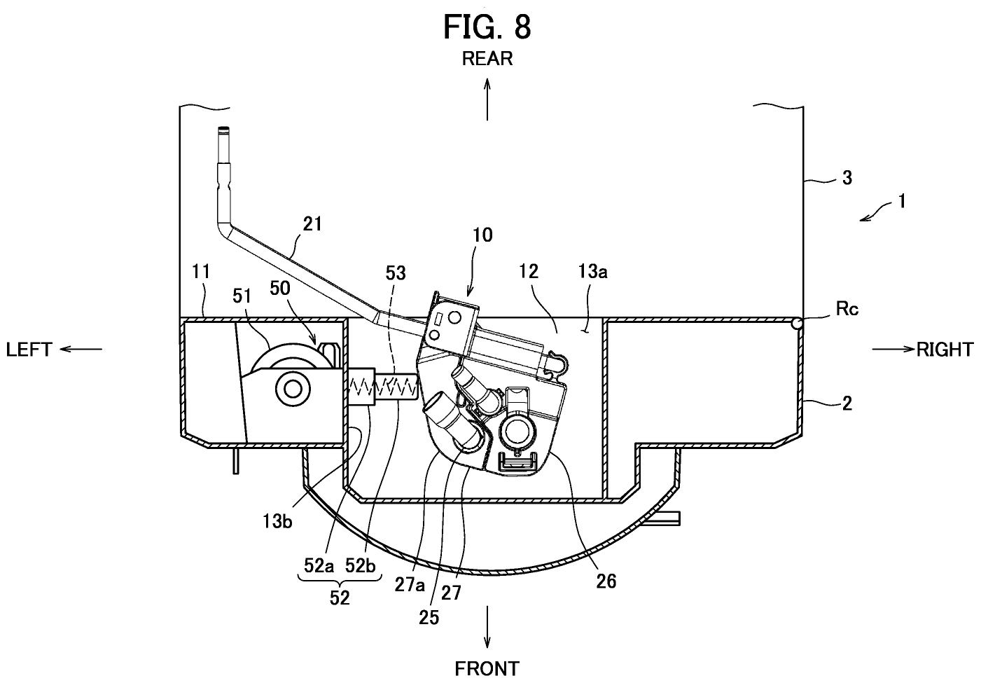

FIG. 8 is a traverse cross-sectional view illustrating states of the nozzle unit 10 and a nozzle moving unit 50 when milk is supplied. FIG. 8 is a cross-sectional view along an A-A part described in FIG. 1, illustrating a state in which the door 2 is closed and the movable nozzle support unit 27 is positioned at the supply position.

As shown in FIG. 8, the door 2 is provided with the nozzle moving unit 50 for moving the movable nozzle support unit 27.

The nozzle moving unit 50 is disposed in an inner space on the movable nozzle support unit 27 side (left side in FIG. 8) with respect to the space 12 storing the nozzle unit 10 of the door 2.

The nozzle moving unit 50 is provided with an electrically driven actuator 51 and a pusher 52 that pushes the movable nozzle support unit 27.

The pusher 52 is provided with a cylindrically formed proximal end part 52a and a distal end part 52b inserted into the proximal end part 52a and extendable/retractable with respect to the proximal end part 52a. The pusher 52 has a compression coil spring 53 that biases the distal end part 52b in the extension direction with respect to the proximal end part 52a.

The pusher 52 is disposed at the same vertical position as that of the movable nozzle support unit 27 and disposed to be movable in the horizontal direction (left-right direction) with respect to the door 2.

A hole through which the proximal end part 52a of the pusher 52 passes is provided in the partition wall 13 that partitions the space 12 in which the nozzle unit 10 is stored on the movable nozzle support unit 27 side, that is, in a partition wall 13b on the left side in FIG. 8. This hole is formed to an extent that it does not touch the proximal end part 52a of the pusher 52 and so as to minimize a gap with the proximal end part 52a.

The actuator 51 has a function of moving the proximal end part 52a of the pusher 52 in the left-right direction with respect to the door 2, and may be constructed of, for example, an electric motor and a mechanism that converts rotation by the electric motor to straight-going motion or may be constructed of a straight-going motion type solenoid. However, an electric motor is more preferable than the solenoid for the actuator 51. Since the electric motor rather than the solenoid can cause the pusher 52 to extend/contract more smoothly, thus allowing the movable nozzle support unit 27 to move smoothly. After milk is supplied, it is thereby possible to prevent milk remaining in the milk nozzle 25 from scattering when the movable nozzle support unit 27 moves.

As shown in FIG. 8, while the door 2 is closed, when the actuator 51 is operated to move the pusher 52 toward the movable nozzle support unit 27, the distal end part 52b of the pusher 52 pushes a side face 27a of the movable nozzle support unit 27. Note that a biasing force by the compression coil spring 53 of the pusher 52 is set to be greater than a biasing force on the movable nozzle support unit 27 by the torsion spring 33 provided in the nozzle unit 10. Therefore, when the actuator 51 is operated to cause the distal end part 52b of the pusher 52 to push the movable nozzle support unit 27, the movable nozzle support unit 27 moves toward the fixed nozzle support unit 26. At this time, the position of the pusher 52 is set so that the movable nozzle support unit 27 moves to the supply position.

On the other hand, when the actuator 51 performs contraction motion to cause the pusher 52 to move in a direction away from the movable nozzle support unit 27, the movable nozzle support unit 27 moves to the standby position by a biasing force of the torsion spring 33, and the amount of movement of the pusher 52 is set so that the distal end part 52b of the pusher 52 moves away from the movable nozzle support unit 27.

As shown in FIG. 8, the side face 27a of the movable nozzle support unit 27 to which the distal end part 52b of the pusher 52 comes into contact is chamfered roundly so as to have a substantially arcuate shape centered on a swing fulcrum Rc for opening/closing the door 2 in the movable nozzle support unit 27 located at the supply position.

The coffee machine 1 in the above configuration operates and controls the actuator 51 of the nozzle moving unit 50 to cause the pusher 52 to perform extension motion only when milk or the like is supplied from the milk nozzle 25 and moves the movable nozzle support unit 27 to the supply position. Except in the case where milk is supplied, for example, after milk is supplied, the actuator 51 causes the pusher 52 to perform contraction motion to thereby move the movable nozzle support unit 27 to the standby position.

After milk is supplied, since the movable nozzle support unit 27 moves to the standby position, even when post-drip of milk drips from the milk nozzle 25, the milk drops into the tray 20a of the nozzle lower tray 20, passes through the cylinder part 20b and is discharged into the drainage tray 28. Thus, it is then possible to prevent post-drip of milk from mixing into the cup C placed at the cup station 7. Therefore, when a beverage not using milk such as straight coffee is provided to the next cup, it is possible to prevent a mixture of milk and safely provide a beverage not using milk to, for example, a user having allergy to milk with the next cup.

Note that the coffee machine 1 according to the present embodiment is provided with a cleaning unit (not shown) that discharges compressed air and hot water from the milk nozzle 25. Every time after supplying milk from the milk nozzle 25, the coffee machine 1 discharges air from the milk nozzle 25 for a certain time first, then discharges hot water and thereby enables rising operation to clean the milk nozzle 25 and a milk supply path.

In the present embodiment, through control whereby the movable nozzle support unit 27 is moved to the standby position after milk is supplied to then perform rinsing operation, it is possible to receive milk or hot water remaining in the milk supply path after being poured from the milk nozzle 25 by the tray 20a of the nozzle lower tray 20 and prevent the milk from scattering to the partition wall 13 or the like. The coffee machine 1 is provided with a locking mechanism for locking the slide door 6 during rinsing operation. However, due to a failure of this locking mechanism or damage to the slide door 6, even if the operator's finger is mistakenly placed in the cup station 7 during the rinsing operation, hot water discharged from the milk nozzle 25 is received by the tray 20a of the nozzle lower tray 20, and so it is possible to avoid burning of a hand or finger.

Furthermore, since the tray 20a is provided below the coffee nozzle 23 or the hot water/water nozzle 24, even when a liquid such as coffee scatters from the coffee nozzle 23 or the hot water/water nozzle 24, the tray 20a of the nozzle lower tray 20 receives it, thus making it possible to prevent scattering of the coffee over the partition wall 13 or the like.

When performing maintenance such as cleaning of the nozzle unit 10 in the coffee machine 1 of the present embodiment, by opening the door 2 and removing the nozzle unit 10 from the support member 21, it is possible to clean the buffer 22 and each nozzle 23, 24 or 25. The nozzle lower tray 20 can also be removed from the body part 3 and cleaned.

In the coffee machine 1 of the present embodiment, the nozzle moving unit 50 that operates the movable nozzle support unit 27 is provided separately from the nozzle unit 10 and the nozzle moving unit 50 need not be removed when cleaning the nozzle unit 10, making it possible to easily perform maintenance such as cleaning of the nozzle unit 10. Furthermore, since the nozzle moving unit 50 is provided in the door 2, the nozzle unit 10 and the body part 3 can be separated from each other by opening the door 2 during maintenance. Even when internal cleaning is performed whereby the inside of the nozzle unit 10 set in the body part 3 or the inside of the body part 3 in the periphery is cleaned with hot water, it is possible to prevent scattering over the actuator 51 of the nozzle moving unit 50 and protect the actuator 51.

Since the movable nozzle support unit 27 is biased to the standby position by the torsion spring 33, if the pusher 52 is in a contracted state, the milk nozzle 25 can be reliably positioned above the tray 20a of the nozzle lower tray 20. When the door 2 is mistakenly opened while milk is being poured from the milk nozzle 25, the pusher 52 is separated and the movable nozzle support unit 27 is moved to the standby position by the torsion spring 33, and so even when milk continues to be poured from the milk nozzle 25, the milk is discharged into the nozzle lower tray 20, making it possible to prevent the milk from spoiling areas of the body part 3 below the nozzle unit 10.

The pusher 52 that moves the movable nozzle support unit 27 can be moved by the actuator 51 of the nozzle moving unit 50 and the distal end part 52b has a two-stage extendable structure. The distal end part 52b is biased in the extension direction by the compression coil spring 53 and even when the movable nozzle support unit 27 is operated at the supply position, the distal end part 52b is biased in the extension direction by the compression coil spring 53 and the movable nozzle support unit 27 is biased toward the fixed nozzle support unit 26 side, and so when milk is supplied, it is possible to position the movable nozzle support unit 27 to ensure that the movable nozzle support unit 27 comes into contact with the fixed nozzle support unit 26. Thus, when milk is supplied, it is possible to cause milk poured from the milk nozzle 25 to pass through the hole 43 of the nozzle lower tray 20 and reliably supply the milk into the cup C placed at the cup station 7.

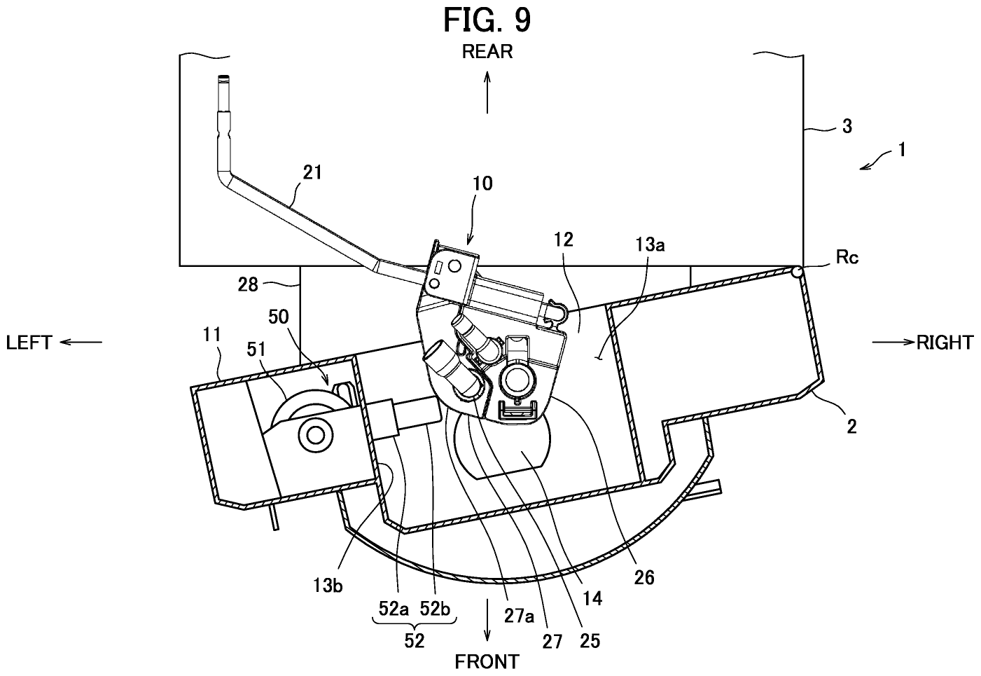

FIG. 9 is a traverse cross-sectional view illustrating states of the nozzle unit 10 and the nozzle moving unit 50 while the door 2 is being opened. As in the case of FIG. 8, FIG. 9 is a cross-sectional view along an A-A part described in FIG. 1.

As shown in FIG. 9, since the side face 27a of the movable nozzle support unit 27 is chamfered roundly so as to have a substantially arcuate shape centered on a swing fulcrum Rc of the door 2, even when the actuator 51 is stopped when the pusher 52 extends and protrudes due to a power failure or fault or the like, the door 2 can be opened/closed without being caught in the movable nozzle support unit 27. Since the distal end part 52b of the pusher 52 has an extendible structure, when the actuator 51 is stopped while the pusher 52 has extended and protruded, the door 2 can be easily opened/closed when the door 2 is opened/closed. The interior of the body part 3 can be thereby inspected.

Since the movable nozzle support unit 27 and the fixed nozzle support unit 26 are provided with the through holes 35a and 35b communicating therewith with the movable nozzle support unit 27 set at the supply position, by inserting a pin or a distal end of the key 4 into the through hole 35a or 35b with the movable nozzle support unit 27 pushed at the supply position, it is possible to hold the movable nozzle support unit 27 at the supply position. In this way, when the door 2 is opened, when checking to see whether or not, for example, a predetermined amount of milk is poured from the milk nozzle 25, it is possible to easily confirm the amount of milk supplied by causing the milk to be poured into the cup placed below the nozzle unit 10. When performing maintenance operation of cleaning a milk supply system such as the milk nozzle 25 while discharging hot water, a large drainage recipient may be placed below the nozzle unit 10 to make it possible to discharge a large amount of hot water from the milk nozzle 25 and sufficiently clean the milk supply system.

Note that after the milk supply, the actuator 51 may be controlled so as to repeat extension/contraction motion several times after restricting the amount of extension of the pusher 52 so that the milk nozzle 25 moves between the standby position and the first partition part 46, and the movable nozzle support unit 27 may be caused to swing in the vicinity of the standby position. By causing the movable nozzle support unit 27 to swing several times after the milk supply, it is possible to shake milk remaining in the milk nozzle 25 off and discharge the milk into the tray 20a of the nozzle lower tray 20. It is thereby possible to further prevent post-drip of milk after the milk supply.

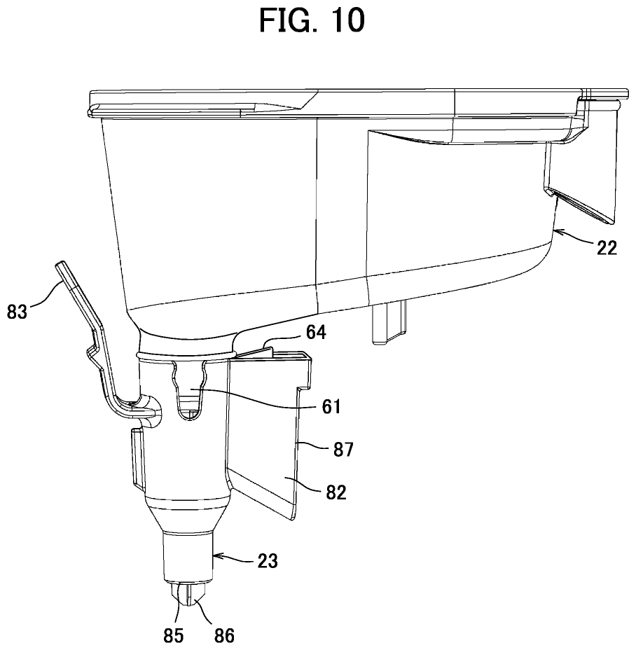

Next, a post-drip prevention structure in the coffee nozzle 23 will be described using FIG. 10 to FIG. 16.

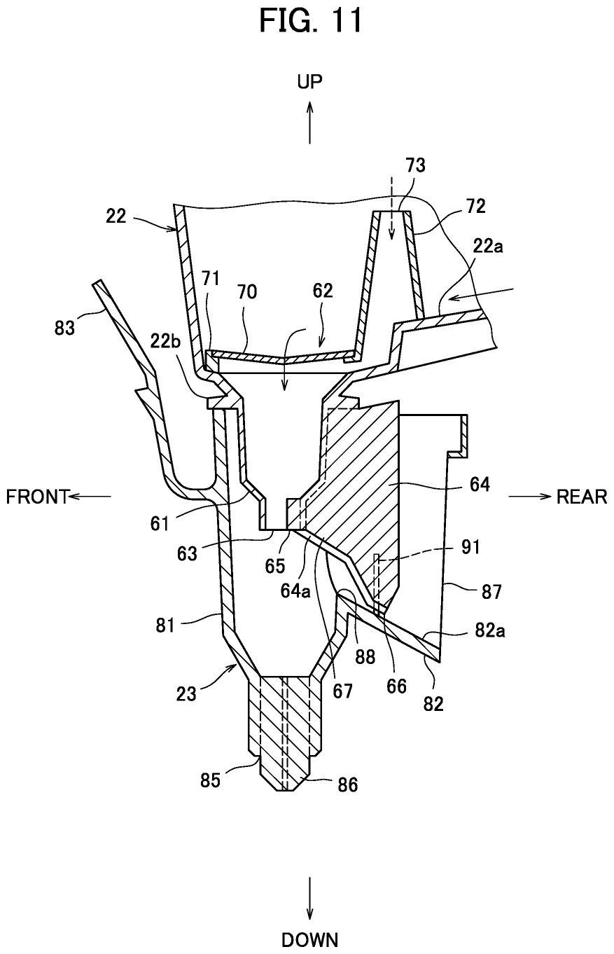

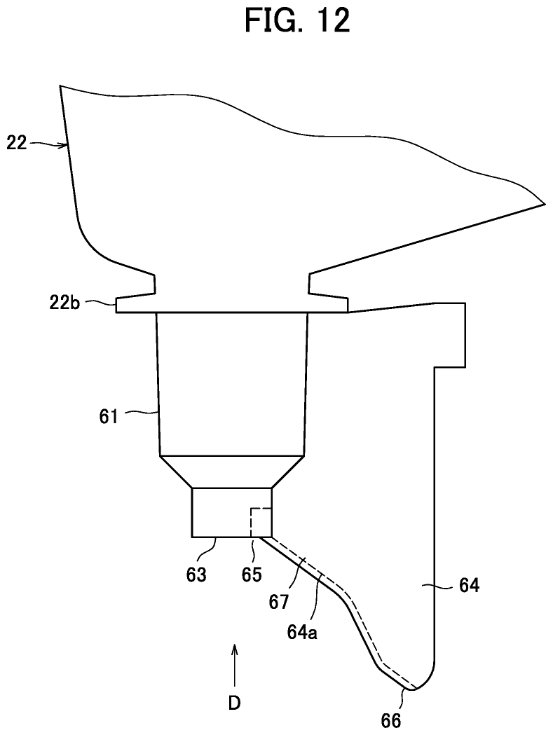

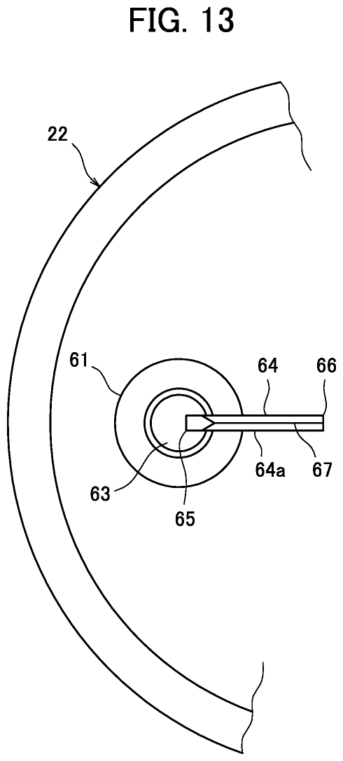

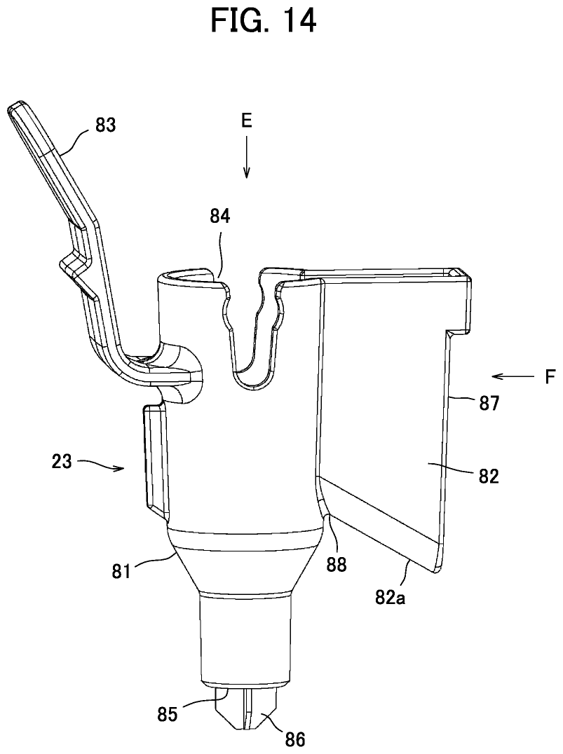

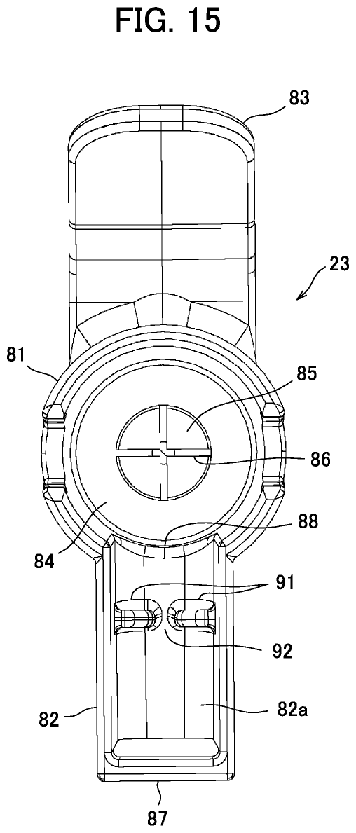

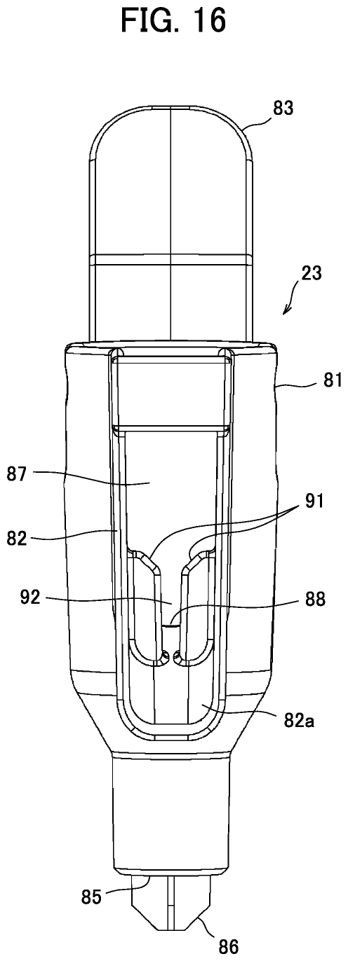

FIG. 10 is a side view illustrating configurations of the buffer 22 and the coffee nozzle 23. FIG. 11 is a longitudinal cross-sectional view of the buffer 22 and the coffee nozzle 23. FIG. 12 is a side view of the buffer 22 in the vicinity of the buffer nozzle 61. FIG. 13 is a bottom view illustrating a shape of the buffer 22 in the vicinity of the buffer nozzle 61. FIG. 14 is a side view illustrating the shape of the coffee nozzle 23. FIG. 15 is a top view illustrating the shape of the coffee nozzle 23. FIG. 16 is a rear view illustrating the shape of the coffee nozzle 23.

Note that FIG. 13 is a diagram viewing from an arrow D direction shown in FIG. 12. FIG. 15 is a diagram viewing from an arrow E direction shown in FIG. 14. FIG. 16 is a diagram viewing from an arrow F direction shown in FIG. 14.

As shown in FIGS. 10 and 11, the cylindrical coffee nozzle 23 is connected below the buffer 22.

The buffer 22 is a recipient for temporarily storing coffee supplied from the coffee extraction unit and even if the amount of coffee supplied from the coffee extraction unit fluctuates, the buffer 22 temporarily stores the coffee, thus allowing a constant amount of coffee to be stably supplied into the cup C. A filter 62 is provided in the buffer 22 and has a function of finally filtering residues from coffee supplied from the coffee extraction unit and also erasing large bubbles.

A buffer nozzle 61 (second nozzle, nozzle) which is a cylindrical nozzle is provided below the buffer 22. A pour spout 63 for pouring coffee supplied into the buffer 22 is provided at a bottom end part of the buffer nozzle 61. The buffer nozzle 61 is coupled with the coffee nozzle 23 by inserting the buffer nozzle 61 from above the cylindrical coffee nozzle 23.

As shown in FIG. 11, the buffer nozzle 61 below the buffer 22 is cylindrical and an outer diameter and an inner diameter thereof become smaller at the bottom end part. A collar portion 22b that protrudes outward in a diameter direction over an entire circumference in an annular plate shape is provided at a top end part of the buffer nozzle 61, that is, in the vicinity of the bottom of the buffer 22.

The coffee nozzle 23 and the buffer nozzle 61 are arranged coaxially on a vertical line. The buffer nozzle 61 has a structure of pouring coffee vertically downward from the pour spout 63 at the bottom end part, and pouring coffee into the coffee nozzle 23.

Furthermore, a guide 64 protruding outward in one diameter direction is provided on a side face of the buffer nozzle 61. The guide 64 is a flat plate extending an axial direction of the buffer nozzle 61, that is, in the vertical direction and a bottom end part 64a is inclined downward from the pour spout 63 at the bottom end part of the buffer nozzle 61 outward in the diameter direction. The inclination of the bottom end part 64a of the guide 64 is small in the vicinity of the pour spout 63 of the buffer nozzle 61 and large in an outer part in the diameter direction, constituting a two-stage inclination.

As shown in FIGS. 12 and 13, an end part on the pour spout 63 side (hereinafter referred to as a “proximal end part 65”) of the bottom end part 64a of the guide 64 slightly protrudes into the pour spout 63. Furthermore, a V groove 67 (groove) is provided in the bottom end part 64a (undersurface) of the guide 64 from the proximal end part 65 to a lowermost end part 66.

As shown in FIG. 11, the filter 62 provided in the buffer 22 is provided above the buffer nozzle 61. The filter 62 is provided with a disk-shaped mesh part 70, a central part of which is recessed downward and a cylindrical frame member 71 that supports the mesh part 70. The frame member 71 is provided with a cylindrical air intake port 72 which protrudes upward from part of the circumferential portion thereof and a top end of which is opened. When the filter 62 is placed in the buffer 22, the space between the mesh part 70 of the filter 62 and the pour spout 63 of the buffer nozzle 61 is configured to communicate with an upper position in the inner space of the buffer 22 via an air intake port 73 at the top of the air intake port 72.

Note that coffee extracted from the coffee extraction unit is configured to be introduced from the rear side in the buffer 22.

In the buffer 22 configured as described above, as shown by a solid line arrow in FIG. 11, coffee flown into the buffer 22 from the rear side flows on a bottom wall 22a of the buffer 22 toward the mesh part 70 of the filter 62, passes through the mesh part 70 and is poured from the buffer nozzle 61 into the coffee nozzle 23.

As shown in FIGS. 14 to 16, the coffee nozzle 23 is provided with a cylindrical body part 81, both ends of which are opened, a lateral discharge part 82 provided on a side face of the body part 81 and a handle-shaped locking part 83 locked to the fixed nozzle support unit 26, and these parts are integrally molded with, for example, resin.

As shown in FIG. 11, the top end part of the body part 81 of the coffee nozzle 23 has substantially the same diameter as the diameter of the collar portion 22b of the buffer 22, the buffer nozzle 61 is inserted into an opening 84 at the top end part and configured to support the collar portion 22b of the buffer 22. Therefore, when the buffer nozzle 61 is inserted into the opening 84 of the top end part of the coffee nozzle 23, the bottom end part of the buffer nozzle 61, the diameter of which is reduced, and the inner wall of the body part 81 of the coffee nozzle 23 are separated from each other over the entire circumference except the guide 64.

The bottom end part of the body part 81 of the coffee nozzle 23 has a reduced diameter and a hole 85 for pouring coffee vertically downward is provided at the bottom end part of the body part 81. Furthermore, a rectification plate 86, a traverse cross section of which is cross-shaped and a bottom end part of which becomes smaller toward the axial center is fitted into this hole 85.

When the buffer nozzle 61 is inserted into the opening 84 of the top end part of the coffee nozzle 23, the length in the axial direction of the body part 81 of the coffee nozzle 23 is set so that the bottom end part of the buffer nozzle 61 is separated from the rectification plate 86 of the coffee nozzle 23 in the axial center direction (up-down direction).

The lateral discharge part 82 is formed into a trapezoidal box shape, a top surface and both side faces of which are opened and protrudes outward in the diameter direction from the side faces of the body part 81. A width of the opening 87 of both side faces of the lateral discharge part 82 is, for example, on the order of 1 cm and the body part 81 communicates with the inside thereof. The bottom wall 82a of the lateral discharge part 82 is inclined downward from the body part 81 outward in the diameter direction.

As shown in FIGS. 15 and 16, partition plates 91 (discharge restricting means) for partitioning the inside of the lateral discharge part 82 so as to shield it outward in the diameter direction from the proximal end part 88 which is an end part of the bottom wall 82a on the body part 81 side at a position, for example, on the order of 1 cm away up to on the order of 1 to 2 cm upward from the bottom wall 82a is provided in the lateral discharge part 82. A notched part 92 into which the bottom end part of the guide 64 of the buffer nozzle 61 is inserted is provided at the center of the partition plates 91 in the width direction. The notched part 92 is formed from the top end of the partition plates 91 up to the bottom wall 82a and the width thereof is set so that a slight gap is provided when the guide 64 is inserted.

Note that as shown in FIG. 11, when the buffer nozzle 61 is inserted into the coffee nozzle 23 until the collar portion 22b of the buffer 22 comes into contact with the top end part of the body part 81 of the coffee nozzle 23, the vertical length of the guide 64 is set so that a gap is provided between the lowermost end part 66 of the guide 64 of the buffer nozzle 61 and the bottom wall 82a of the lateral discharge part 82.

In the above configuration, coffee supplied from the coffee nozzle 23 is poured from the buffer 22 vertically downward via two nozzles of the buffer nozzle 61 and the coffee nozzle 23 and supplied to the cup C.

When coffee is supplied from the coffee nozzle 23, coffee may remain in the buffer 22 or the filter 62, and post-drip may result after the coffee supply. However, according to the present embodiment, even when post-drip of coffee is about to drip from the pour spout 63 of the buffer nozzle 61, that is, coffee flowing at a flow rate of a predetermined value or less flows along the bottom end part 64a of the guide 64 inclined downward from the proximal end part 65 of the guide 64 and is discharged into the lateral discharge part 82 of the coffee nozzle 23. The coffee flowing along the guide 64 passes through the gap between the guide 64 and the partition plates 91 and is discharged outward in the diameter direction on the bottom wall 82a.

The coffee discharged outward in the diameter direction on the bottom wall 82a of the lateral discharge part 82 is discharged downward from the opening 87 at the end part outward in the diameter direction of the lateral discharge part 82. Since the tray 20a of the nozzle lower tray 20 is located below the outward end part in the diameter direction of the lateral discharge part 82, post-drip of the coffee from the pour spout 63 of the buffer nozzle 61 is discharged from the lateral discharge part 82 and discharged into the drainage tray 28 of the body part 3 via the tray 20a of the nozzle lower tray 20 and the cylinder part 20b.

In this way, it is possible to prevent post-drip after the coffee supply from the coffee nozzle 23. For example, in the case cafe latte, if a post-drip of coffee drips after milk is supplied into the cup C, this may make a poor appearance, but such a problem can be avoided in the present embodiment.

Provision of the filter 62 as described above allows coffee to stay in the buffer 22 and so even in a case like cappuccino where only a small amount of coffee is supplied, large bubbles of coffee can be effectively erased. In the case of a configuration of a coffee extraction unit in which coffee is extracted under pressure using a tube pump, bubbles are likely to be generated due to pressure pulsation by the tube pump, but bubbles of coffee can be sufficiently erased by the buffer 22 and the filter 62 in the present embodiment and a coffee beverage of high quality can be provided.

Since the filter 62 causes the pouring speed of coffee from the buffer nozzle 61 to decrease, especially when regular coffee is extracted, it is possible to reduce the flow rate of a certain portion of miscellaneous flavor at the end of extraction to a predetermined value or less, causing the portion of coffee to be discharged into the nozzle lower tray 20 from the lateral discharge part 82 of the coffee nozzle 23 as post-drip without being supplied into the cup C, and thereby provide coffee of still better quality.

Note that since the filter 62 is provided upstream of the buffer nozzle 61, when the mesh part 70 of the filter 62 after the coffee supply is closed with the coffee liquid or bubbles, the coffee remaining in the buffer nozzle 61 may not be easily discharged just as in the case where for example, an appropriate amount of water is put in a straw and one opening is blocked, water will not flow out from the other opening. However, according to the present embodiment, since the space between the mesh part 70 of the filter 62 and the buffer nozzle 61 is configured to communicate with the upper space in the buffer 22 via the air intake port 73 above the air intake port 72, even when the filter 62 is closed with the coffee liquid or bubbles after the coffee supply, air is introduced through the air intake port 73 as shown by a dotted line arrow in FIG. 11 facilitating discharging of coffee remaining in the buffer nozzle 61. Since the air intake port 73 protrudes upward from the bottom wall 22a of the buffer 22, coffee supplied into the buffer flows above the mesh part 70 without flowing into the air intake port 73. Thus, since the air intake port 72 protrudes upward and is integrated with the mesh part 70 to form the filter 62, when the filter 62 is cleaned, the filter 62 can be easily poured from the buffer 22 by pinching the air intake port 72 and lifting it up, making cleaning easier.

Since the proximal end part 65 of the guide 64 in the buffer nozzle 61 protrudes in the axial center direction at the pour spout 63, a small amount of coffee dripping from the pour spout 63 will not drop on the coffee nozzle 23 side but flow along the guide 64 and is more likely to be discharged into the lateral discharge part 82, making it further possible to prevent post-drip after coffee pouring. Note that in the above embodiment, the proximal end part 65 of the guide 64 protrudes in the pour spout 63, whereas without the proximal end part 65 protruding in the pour spout 63, processing such as emboss processing that will cause a capillary phenomenon on the surface may be applied to the bottom end part 64a of the guide 64 and around at least the proximal end part 65 or preferably including the end part of the pour spout 63 and the vicinity of the bottom end part 64a of the guide 64. Applying such emboss processing or the like makes it easier for the liquid to stay on the surface of the guide 64, preventing coffee from dropping from the guide 64 and facilitating discharging of the coffee along the guide 64 into the lateral discharge part 82 without dropping on the coffee nozzle 23 side.

Since the V groove 67 is provided in the bottom end part 64a of the guide 64, when coffee is about to drip from the pour spout 63, coffee does not drop along the bottom end part 64a of the guide 64, but more easily moves outward in the diameter direction along the V groove 67. When coffee remaining in the buffer nozzle 61 after coffee pouring is discharged from the pour spout 63, the coffee is more likely to flow along the guide 64 without dropping on the coffee nozzle 23 side and further coffee is more easily discharged into the lateral discharge part 82.

The inclination of the bottom end part 64a of the guide 64 is small in the vicinity of the pour spout 63 of the buffer nozzle 61 and large in an outward part in the diameter direction, that is, two-stage inclination, and so it is possible to shorten the length of the guide 64 (dimension of the buffer nozzle 61 in the diameter direction). By reducing the inclination in the vicinity of the pour spout 63 of the buffer nozzle 61 (region on the pour spout 63 side), it is possible to limit the flow rate of coffee guided outward along the bottom end part 64a of the guide 64 from the pour spout 63 to a low level. Therefore, it is possible to supply coffee to the coffee nozzle 23 side without any waste during coffee pouring and pour the coffee from the coffee nozzle 23 and discharge only post-drip of the coffee from the pour spout 63 from the opening 87 of the lateral discharge part 82. By increasing (making steeper) the inclination of the outward part in the diameter direction of the bottom end part of the guide 64 (region outside the region on the pour spout 63 side), it is possible to speedily discharge post-drip of coffee flowing along the bottom end part of the guide 64 from the opening 87 of the lateral discharge part 82.

By providing a pair of partition plates 91 in the lateral discharge part 82 of the coffee nozzle 23 and thereby reducing the cross-sectional area of the channel below the lateral discharge part 82, it is possible to reduce the flow rate of coffee discharged from the lateral discharge part 82. Even when a large amount of coffee flows into the lateral discharge part 82 during coffee supply, the coffee is blocked by the partition plate 91 and discharged to the coffee nozzle 23 side. Therefore, it is possible to prevent wasteful discharge of coffee from the lateral discharge part 82 during the coffee supply, that is, wasteful disposal of coffee.

With the configuration of the present embodiment in which the above buffer nozzle 61 is provided upstream of the coffee nozzle 23, it is possible to prevent post-drip of coffee in a simple configuration without providing any actuator.

Note that the beverage supply apparatus of the present invention is not limited to the above embodiment. For example, the cup station at which a cup is placed is not limited to the cup station 7 provided in the door 2 as described in the above embodiment, but may also have a configuration in which a cup is held by a cup holder or a configuration in which a beverage is supplied into a cup at a predetermined position in the body part 3 and then transferred to a takeout port and provided.

In the above embodiment, the buffer nozzle 61 and the coffee nozzle 23 constitute a nozzle for pouring coffee, but the buffer nozzle 61 and the coffee nozzle 23 may be integrated to constitute one nozzle.

The coffee machine 1 of the above embodiment is configured to supply milk obtained by whipping raw milk from a milk nozzle, but the present invention is also applicable to a coffee machine that supplies milk obtained by dissolving powdered milk in hot water to a cup. The present invention is also widely applicable to an apparatus that provides beverage other than milk or coffee such as cocoa or green tea.

### EXPLANATION OF REFERENCE SIGNS

1 coffee machine (beverage supply apparatus)
7 cup station
23 coffee nozzle (first nozzle, nozzle)
61 buffer nozzle (second nozzle, nozzle)
63 pour spout
64 guide
65 proximal end part (end part)
67 V groove (groove)
91 partition plate (discharge restricting means)
C cup

1. A beverage supply apparatus that supplies a beverage into a cup placed at a cup station from a nozzle, a distal end of which is disposed above the cup, wherein
the nozzle pours the beverage vertically downward, and
a lateral discharge part that discharges the beverage passing through the nozzle at a flow rate equal to or less than a predetermined value to a side of the nozzle is provided.

2. The beverage supply apparatus according to claim 1, wherein the nozzle comprises a first nozzle and a second nozzle disposed above the first nozzle.

3. A beverage supply apparatus that supplies a beverage into a cup placed at a cup station from a first nozzle, a distal end of which is disposed above the cup, wherein
a second nozzle is provided above the first nozzle,
the first nozzle pours the beverage vertically downward, and
a lateral discharge part that discharges the beverage passing through the first nozzle at a flow rate equal to or less than a predetermined value to a side of the nozzle is provided.

4. The beverage supply apparatus according to claim 3, wherein the lateral discharge part discharges post-drip after pouring the beverage from the second nozzle to a side of the first nozzle.

5. The beverage supply apparatus according to claim 4, wherein the second nozzle pours the beverage vertically downward.

6. The beverage supply apparatus according to claim 5, wherein the first nozzle and the second nozzle are disposed coaxially on a vertical line.

7. The beverage supply apparatus according to claim 4, comprising a guide for guiding post-drip of the beverage from a pour spout of the second nozzle to the lateral discharge part.

8. The beverage supply apparatus according to claim 7, wherein an end part of the guide protrudes toward the pour spout of the second nozzle.

9. The beverage supply apparatus according to claim 7, wherein an undersurface of the guide is treated to produce a capillary phenomenon.

10. The beverage supply apparatus according to claim 9, wherein the treatment to produce a capillary phenomenon is a groove provided in the undersurface of the guide.

11. The beverage supply apparatus according to claim 7, wherein the bottom end part of the guide is inclined diagonally downward from the pour spout of the second nozzle toward the outside.

12. The beverage supply apparatus according to claim 11, wherein the bottom end part of the guide is inclined at two stages such that a region outside the region on the pour spout side of the second nozzle is more steeply inclined.

13. The beverage supply apparatus according to claim 3, wherein the lateral discharge part comprises discharge restricting means for damming up beverage discharge at a flow rate equal to or above a predetermined value to a side of the first nozzle.
